(19) United States
(12) Patent Application Publication
(10) Pub. No.: US 2016/0091669 A1
(43) Pub. Date: Mar. 31, 2016

(54) Electrical Connector with Optical Channel

(71) Applicant: Silicon Image, Inc., Sunnyvale, CA (US)

(72) Inventors: Neil Bullock, San Jose, CA (US); Kihong Kim, San Jose, CA (US); Joohong Choi, Stanford, CA (US)

(21) Appl. No.: 14/502,928

(22) Filed: Sep. 30, 2014

(51) Int. Cl. G02B 6/38; H01R 13/658; H01R 24/64

(52) U.S. Cl. CPC G02B 6/3817; H01R 24/64; H01R 13/658

(57) ABSTRACT

A hybridized connector is based on an existing standard for an electrical connector but also provides an optical channel for increased data rate.

### BACKGROUND

1. Field of the Disclosure

This disclosure pertains in general to connectors for data communications.

2. Description of the Related Art

Electrical connectors are an important component for the compute and networking ecosystem. There is a large installed base and continuing strong demand for electrical connectors. There is also significant price pressure on electrical connectors. Most electrical connectors are specified by standards to insure interoperability. The use of standardized connectors also increases the overall volume for the standardized connector, which results in lower prices. However, electrical connectors use electrical conductors to transmit data and electrical conductors are limited in data rate, particularly in light of the increasing demand for bandwidth driven by video and other data-intensive applications.

Therefore, there is a need for improved connectors.

### SUMMARY

Embodiments of the present disclosure are related to connectors that are based on existing electrical connectors but which also provide an optical channel for increased data rate. For convenience, these will be referred to as hybridized electrical connectors, because they are versions of electrical connectors which have been modified to become hybrid optical/electrical connectors.

In one aspect, a hybridized electrical connector is intended to mate with a counterpart connector. The hybridized electrical connector includes electrical contacts supported by a mechanical interface, which are compliant with a standard that specifies only electrical data channels. Examples of such standards include USB, FireWire, Ethernet, HDMI, DVI and eSATA. The hybridized electrical connector also includes an optical transport structure. When the hybridized electrical connector is mated with the counterpart connector, the optical transport structure and a counterpart transport structure in the counterpart connector form an optical data pathway through the mated connectors.

The connectors typically connect to optical fibers on the cable-side. In this way, an optical channel is made available while still maintaining compatibility with the standard. The optical channel may (or may not) also be specified in a standard. Since optical fibers typically have much higher bandwidth than electrical conductors, the optical channel can provide a data rate that exceeds the data rate specified by the standard for the electrical data channels.

The optical transport structure preferably is implemented as part of the existing structure of the electrical connector. For example, electrical connectors typically include a mechanical support for the electrical contacts, and the optical channel may be implemented as part of the support structure. Alternately, it may be implemented as part of the connector housing, or as part of other mechanical structures specified by the standard. Alternatively, it may also be implemented as a new structure not specified by the standard, but preferably in a manner that is compatible with the standard. For example, the mechanical alignment tolerances for the optical channel preferably are consistent with the mechanical tolerances specified by the standard.

The optical transport structure can also be implemented in different ways: made from optically transparent material or as a hollow waveguide, for example. The structure preferably is designed so that it does not add significant cost to the connector. Thus, it is preferable to have lower component counts, lower cost components, and lower cost assembly. The optical transport structure can be manufactured by a variety of methods, including molding, deposition and etching, printing, and stamping. The optical transport structure can be an arbitrary shape. The structure with the most suitable characteristics (e.g., performance, cost) for the connector can be chosen.

Another aspect includes a cable using such hybridized electrical connectors. For example, the cable may include two such connectors, one on either end. The cable itself includes electrical conductors to connect corresponding electrical contacts on the two end connectors, but it would also include one or more optical fibers to connect to the corresponding optical transport structures on the two end connectors.

Other aspects include components, devices, systems, improvements, methods, processes, applications and other technologies related to the foregoing.

### BRIEF DESCRIPTION OF THE DRAWINGS

The teachings of the embodiments disclosed herein can be readily understood by considering the following detailed description in conjunction with the accompanying drawings.

FIG. 1a is a front view and top view section of a hybridized USB Type A plug.

FIG. 1b is a front view and top view section of a hybridized USB Type A receptacle.

FIG. 1c is a perspective view of the hybridized USB Type A plug of FIG. 1a.

FIGS. 2a-c show side view cross sections of examples where two hybridized USB Type A connectors are mated.

FIGS. 3a-b show another design for a hybridized USB Type A plug and a corresponding USB Type A receptacle.

FIGS. 4a-b show another design for hybridized USB Type A connectors.

FIG. 5 is a perspective view of additional designs for hybridized USB Type B connectors.

FIG. 6 is a perspective view of a hybridized RJ45 connector.

FIG. 7 is a diagram of a hybridized cable.

### DETAILED DESCRIPTION

The Figures (FIG.) and the following description relate to various embodiments by way of illustration only. It should be noted that from the following discussion, alternative embodiments of the structures and methods disclosed herein will be readily recognized as viable alternatives that may be employed without departing from the principles discussed herein. Reference will now be made in detail to several embodiments, examples of which are illustrated in the accompanying figures. It is noted that wherever practicable similar or like reference numbers may be used in the figures and may indicate similar or like functionality.

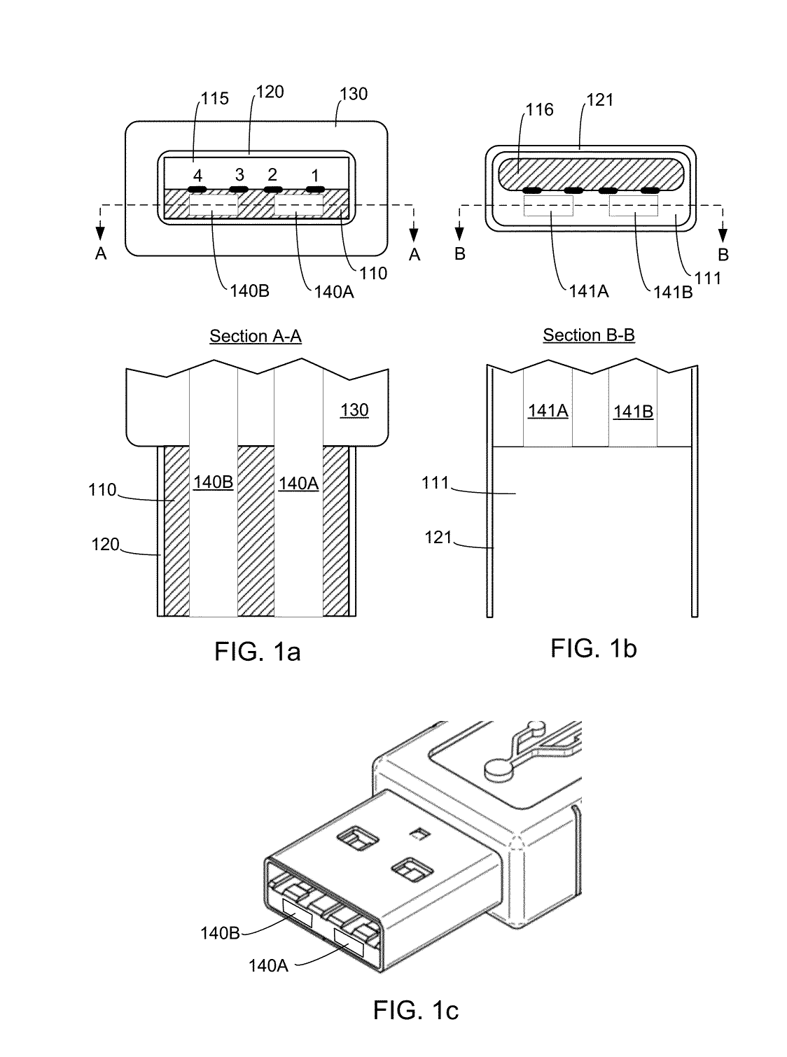

FIGS. 1a-b are diagrams of hybridized USB Type A connectors. USB connectors come in mating pairs, with one connector referred to as a plug and the other as the receptacle. The plug typically connects to a cable (i.e., is cable-facing), and the receptacle typically connects to a device (i.e., is device-facing). Connector pairs may also be referred to as male/female. FIG. 1a shows a front view and a top view of section A-A of the plug. FIG. 1b shows a front view and a top view of section B-B of the receptacle. FIG. 1c shows a perspective view of the plug. Referring first to FIG. 1a, the plug includes four electrical contacts 1-4, which are specified by the USB standard and which are mechanically supported by an insulating material 110, indicated by cross-hatching. The plug also includes shielding 120, which also serves as part of the mechanical interface of the USB connector. The shielding forms a cavity 115 above the electrical contacts 1-4. A boot 130 forms part of the housing for the connector.

In FIG. 1b, the receptacle has corresponding electrical contacts, which are supported by insulating material 116. The receptacle also has shielding 121, which forms a cavity 111. When the plug and receptacle are mated, corresponding electrical contacts 1-4 make contact with each other, thus completing electrical data pathways through the mated connectors as specified by the USB standard. Mechanically, the shielding 120 of the plug fits inside the shielding 121 of the receptacle. Support structure 110 of the plug inserts into cavity 111 of the receptacle, and support structure 116 of the receptacle inserts into cavity 115 of the plug. Mechanical alignment and locking structures are omitted for clarity.

In this example, the support structure 110 is modified to provide two optical data pathways through the connectors. The support structure 110 includes two optical transport structures 140A,B. These are constructed of optically transparent material and act as optical waveguides. In this example, each structure 140 is rectangular in cross section. In one design, each structure 140 has highest refractive index at the center of the rectangle, with decreasing refractive index towards the edge of the rectangle. The change in refractive index could be implemented by using gradient index materials. Alternatively, it could be implemented by using layers (or rectangular annuli) of decreasing index traveling outwards from the center.

FIG. 1b shows the corresponding transport structures 141A,B on the receptacle. In this example, these structures 141 have the same rectangular construction as structures 140.

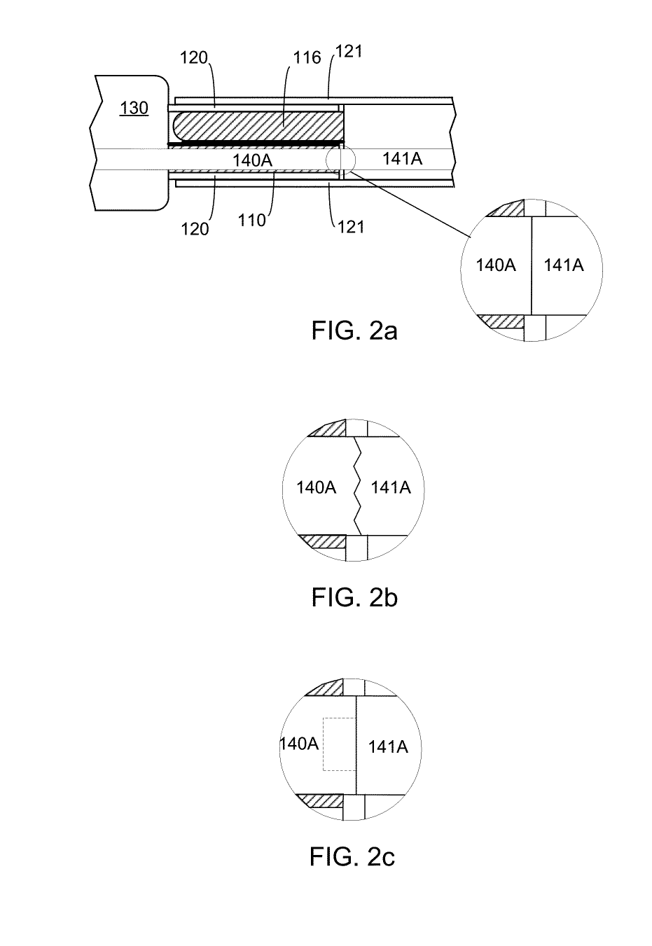

FIG. 2a shows a side view cross section when the two connectors are mated. FIG. 2a includes a magnification of the area where the two optical transport structures 140A-141A contact each other. In this example, the corresponding optical transport structures 140A-141A are butt coupled. They are referred to as optical transport structures because each is typically coupled to an optical fiber on their other ends (not shown) and the optical transport structures provide a transition from one fiber to the other. The structures 140,141 are sufficient to provide this level of optical coupling, but they typically are not suitable for long distance transmission. For example, the structures 140,141 may be shaped so that they are optically diverging or converging. Structures 140,141 are also part of a connector, so they preferably are designed in a manner that is consistent with the cost, tolerance and other requirements for connectors. For example, the optical structures could be manufactured by molding, deposition and etching, printing, or stamping. They preferably also are robust against shock, vibration, pressure, contamination, temperature, external light and other connector requirements.

FIG. 2b shows another example where the faces of the two optical transport structures 140,141 are not flat. Rather, they have beveled facets to actively create pressure between the two structures, thus increasing optical coupling between the two. However, the facets are shallow enough that these hybridized connectors can still be used with conventional Type A connectors.

FIG. 2c shows another example where one optical transport structure 141A has a protrusion (depicted by the dashed line) that fits into a cavity in the other optical transport structure 140A. In this example, the optical transport structures 140,141 maintain symmetry, which can be useful to reduce interference at the transition point. Gradient index or layered refractive index material could also be used in the optical transport structures 140,141. The optical transport structures 140,141 preferably are designed so that the mechanical tolerances specified by the USB standard will provide sufficient optical coupling between the structures 140,141.

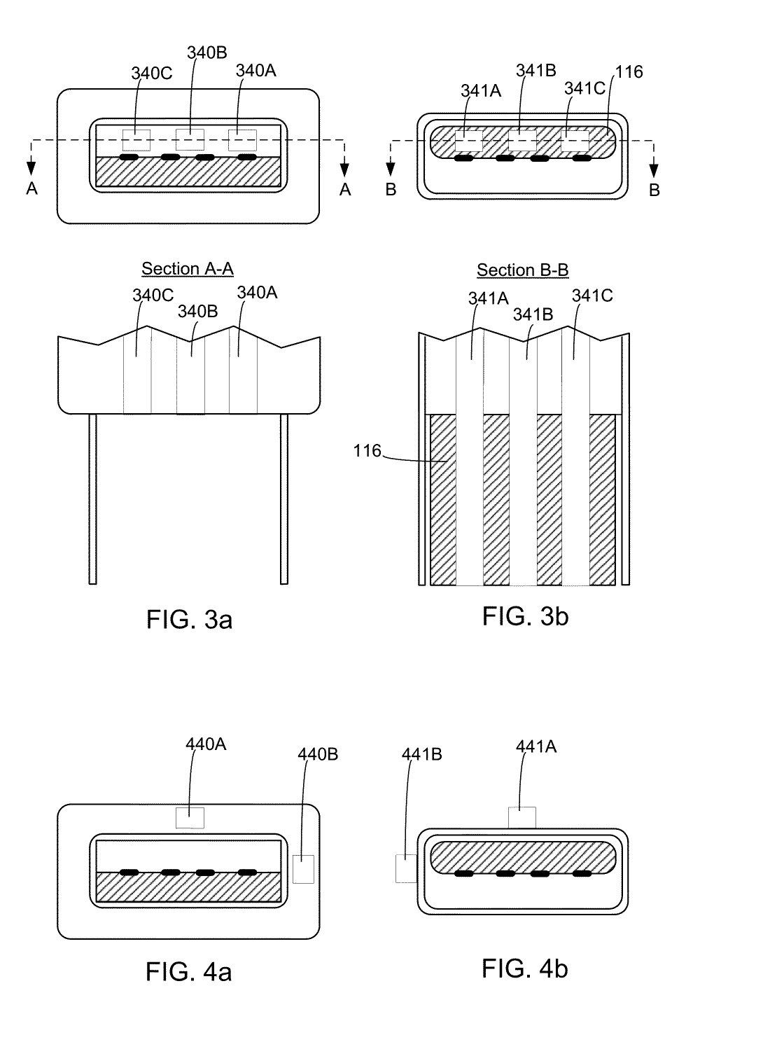

FIGS. 3a-3b show another design in which optical transport structures 340,341 are implemented as part of support structure 116 of the receptacle and the corresponding mating face in the plug. This example includes three optical data pathways 340,341A,B,C. FIG. 3a shows implementation of optical transport structures 340A-C in the plug. FIG. 3b shows implementation of the corresponding optical transport structures 341A-C in the receptacle.

FIGS. 1-3 show designs where the optical transport structures were part of a support structure for the electrical contracts and also where the optical transport structures were located internal to the shielding. This is not required. FIGS. 4a-b show a design where extra structure 440,441 is added outside the shielding. This example shows one optical data pathway 440,441A located on the top of the connector housing. In an alternate design, the optical data pathway 440,441B could be located on the side (or at other locations). FIG. 4a shows implementation of optical transport structures 440A-B in the plug, and FIG. 4b shows implementation of the corresponding optical transport structures 441A-B in the receptacle.

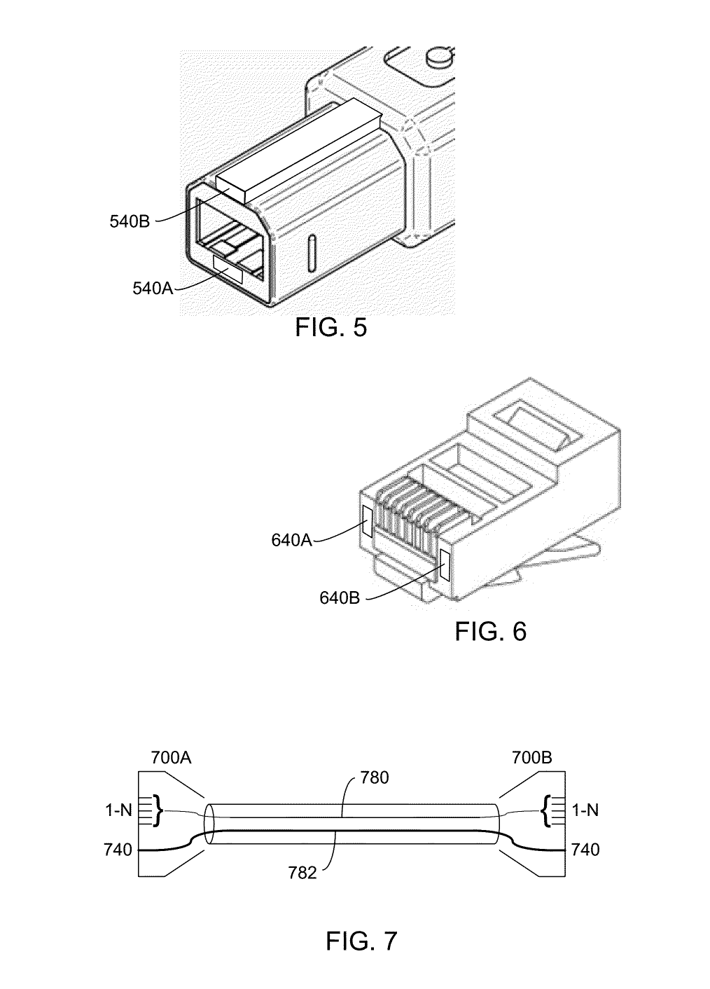

FIG. 5 shows additional designs for hybridized USB Type B connectors. FIG. 5 is a perspective view of the USB Type B plug. As with the Type A connectors, optical transport structures could be located at various positions on the Type B connector. For example, the optical data pathway 540A could be implemented as part of the support structure in the plug. Alternately, it 540B could be implemented external to the shielding, for example as part of a mechanical structure not required by the USB standard. It could also be implemented as part of the support structure in the receptacle or (not shown in FIG. 5).

The optical data pathway could also be implemented as a hollow waveguide, rather than as a dielectric waveguide as described above, In FIG. 5, optical data pathway 540A,B could be created by hollowing out the interior of the support structure and then mirroring the surfaces (in a manner that does not short or otherwise compromise the electrical contacts.

The above examples were all for the USB standard, but the invention is not limited to the USB standard. For example, it may also be applied to FireWire, Ethernet, MIDI, HDMI, DVI, MHL, VGA, eSATA, PCIe, Thunderbolt, SCSI or RJx (i.e., RJ11, RJ45, etc.) standards. It may also be applied to VESA, coaxial cable, electrical cables (e.g. IEC), memory cards (e.g. SD Card), and microphone/headphone connectors. FIG. 6 is a front view of a hybridized RJ45 connector (only the plug is shown). In this example, the optical pathways 640 are implemented to either side of the set of electrical contacts.

FIG. 7 is a diagram of a hybridized cable. The cable includes two hybridized connectors 700A,B connected by a combination of electrical conductors and optical fibers. Each hybridized connector 700 includes electrical contacts 1-N, which are connected by electrical conductors 780. This provides the electrical data channels specified by the applicable standard. The hybridized connectors 700 also include optical transport structures 740, typically connected by optical fibers 782. This provides the additional optical data channels.

When used with hybridized counterpart connectors, data can be transmitted over both the electrical and optical data channels. The optical data channels can be used as a supplement to the electrical data channels or independently of the electrical data channels. In some applications, only the optical data channels might be used and the electrical data channels may not be used at all. When used with legacy counterpart connectors, the cable preferably should function as a legacy cable, providing full functionality for the electrical data channels.

Upon reading this disclosure, those of skill in the art will appreciate still additional alternative designs. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed is:

1. A hybridized electrical connector for mating with a counterpart connector, the hybridized electrical connector comprising:
a plurality of electrical contacts supported by a mechanical interface, the electrical contacts and mechanical interface compliant with a standard that specifies only electrical data channels; and
an optical transport structure, wherein the optical transport structure and a counterpart transport structure on the counterpart connector form an optical data pathway through the hybridized electrical connector and counterpart connector when the two connectors are mated.

2. The hybridized electrical connector of claim 1 wherein the optical data pathway has a data capacity that exceeds a data rate specified by the standard for the electrical data channels.

3. The hybridized electrical connector of claim 1 wherein the hybridized electrical connector is backwards compatible with legacy counterpart connectors that are compliant with the standard but that do not have a counterpart transport structure.

4. The hybridized electrical connector of claim 1 further comprising a support structure for the electrical contacts, wherein the optical transport structure is part of the support structure.

5. The hybridized electrical connector of claim 1 further comprising electrical shielding, wherein the optical transport structure is located inside the electrical shielding.

6. The hybridized electrical connector of claim 1 further comprising electrical shielding, wherein the optical transport structure is located outside the electrical shielding.

7. The hybridized electrical connector of claim 1 further comprising a housing, wherein the optical transport structure is part of the housing.

8. The hybridized electrical connector of claim 1 wherein the optical transport structure is part of a mechanical structure specified by the standard.

9. The hybridized electrical connector of claim 1 wherein the optical transport structure is part of a mechanical structure that is not specified by the standard.

10. The hybridized electrical connector of claim 1 wherein the optical transport structure comprises an optically transparent material of rectangular cross section.

11. The hybridized electrical connector of claim 10 wherein the optical transport structure has a refractive index that is highest at a center of the rectangular cross section and decreases towards an edge of the rectangular cross section.

12. The hybridized electrical connector of claim 10 wherein the optical transport structure comprises concentric rectangular annuli of optically transparent material.

13. The hybridized electrical connector of claim 1 wherein the optical transport structure comprises a rectangular hollow waveguide.

14. The hybridized electrical connector of claim 1 wherein the optical transport structure is created by molding or stamping.

15. The hybridized electrical connector of claim 1 wherein the optical transport structure has a mechanical alignment tolerance that is consistent with mechanical tolerances specified by the standard.

16. The hybridized electrical connector of claim 1 wherein the optical transport structure includes two ends, one end adapted to be coupled to the counterpart transport structure to form the optical pathway, and the other end adapted to be coupled to an optical fiber.

17. The hybridized electrical connector of claim 1 wherein the standard is a USB standard.

18. The hybridized electrical connector of claim 1 wherein the standard is one of the following: a FireWire standard, an Ethernet standard, a Thunderbolt standard, a SCSI standard, or an RJx standard.

19. The hybridized electrical connector of claim 1 wherein the standard is one of the following: an HDMI standard, a DVI standard, or an MHL standard.

20. The hybridized electrical connector of claim 1 wherein the hybridized electrical connector and counterpart connector form a pair that is one of the following: a plug/receptacle pair, a male/female pair, and a cable-facing/device-facing pair.

21. A hybridized cable comprising:
two hybridized electrical connectors, each hybridized electrical connector comprising:
a plurality of electrical contacts supported by a mechanical interface, the electrical contacts and mechanical interface compliant with a standard that specifies only electrical data channels; and
an optical transport structure, wherein the optical transport structure and a counterpart transport structure on a counterpart connector form an optical data pathway through the hybridized electrical connector and counterpart connector when the two connectors are mated;
electrical conductors connecting corresponding electrical contacts on the two hybridized electrical connectors; and
on the two hybridized electrical connectors.
